(19) United States
(12) Patent Application Publication
(10) Pub. No.: US 2009/0092722 A1
(43) Pub. Date: Apr. 9, 2009

(54) JUICE EXTRACTOR

(75) Inventors: Geoffrey Michael BURLINGTON, Malmesbury (GB); Roy Edward POULTON, Malmesbury (GB)

Correspondence Address: MORRISON & FOERSTER LLP, 1650 TYSONS BOULEVARD, SUITE 400, MCLEAN, VA, 22102, US

(73) Assignee: Dyson Technology Limited, Malmesbury (GB)

(21) Appl. No.: 12/212,455

(22) Filed: Sep. 17, 2008

(30) Foreign Application Priority Data
Oct. 3, 2007 (GB) 0719354.3

(51) Int. Cl. A23N 1/00; A47J 19/02; B30B 9/02

(52) U.S. Cl. 426/489; 100/37; 100/193; 100/208; 99/495

(57) ABSTRACT

A juice extractor for extracting juice from comestibles such as fruit and vegetables includes at least one wall delimiting a cavity for receiving the comestible and that has a longitudinal axis. At least a part of the wall of the cavity is moveable transversely towards the longitudinal axis so as to apply a compressive force to the comestible in a substantially radial direction relative to the longitudinal axis. This results in good juice extraction while reducing the risk of the skin of the comestible splitting for a variety of comestible sizes. The risk of contamination by zest or peel oil is therefore reduced. The juice extractor is suitable for domestic use and requires no preparation of the comestibles prior to the juice extraction process being carried out.

### REFERENCE TO RELATED APPLICATIONS

This application claims the priority of United Kingdom Application No. 0719354.3, filed Oct. 3, 2007, the contents of which are incorporated herein by reference.

### FIELD OF THE INVENTION

The invention relates to a juice extractor for extracting juice from comestibles such as fruits and vegetables. Particularly, but not exclusively, the invention relates to a juice extractor for extracting juice from fruits having a rind, more particularly citrus fruits. The invention is particularly relevant to a juice extractor for domestic use.

### BACKGROUND OF THE INVENTION

Domestic juice extractors generally fall into one of several categories. One category is the citrus juicer which operates in a manner similar to a common lemon squeezer by applying a pressing force to a halved fruit placed on a ridged cone. The cone may rotate so as to maximise juice extraction. A second category is the centrifugal juicer which grates peeled and chopped fruit or vegetables into a mesh basket which spins so as to retain the pulp therein while allowing juice to be released through the basket walls. A further category of juicer is the masticating juicer which simply chops peeled fruit or vegetables very finely and separates the juice from any flesh or pulp. Finally, twin-gear juicers work by crushing and pressing the fruit or vegetables to extract juice therefrom.

A disadvantage of each of these types of juice extractor is that any fruit or vegetables to be juiced must be prepared before juicing can commence. In most cases, the fruit or vegetables must be peeled and chopped; even in the case of citrus juicers, the fruit must be cut in half by the user before juicing can take place. This makes the juicing process more time-consuming and messy than it need be. Another disadvantage of known juice extractors is that cleaning the appliance after use is often awkward and time-consuming.

Industrial juicers have been developed which are able to deal with whole fruit without any need for preparation. Typically, an industrial juicer will cut an opening through the rind of a citrus fruit and then compress the fruit in an axial direction to extract juice from the fruit. Examples of this type of industrial juicer are shown in GB 1,016,644, U.S. Pat. No. 3,682,092 and U.S. Pat. No. 3,831,515. One of the disadvantages of industrial juicers of this type is that they are comparatively large and heavy and therefore unsuitable for domestic use. They also have the disadvantage that the skins can split releasing zest or peel oil which may contaminate the juice leaving a bitter aftertaste. This is particularly problematic if relatively small fruits are being juiced because a gap will exist between the fruit and the cup in which the fruit sits allowing the fruit to split outwardly when compression takes place.

### SUMMARY OF THE INVENTION

It is an object of the present invention to provide a juice extractor which operates effectively to extract juice from comestibles, such as fruit and vegetables, of different sizes while minimising the risk of splitting the skin thereof. It is a further object of the present invention to provide a juice extractor which is effective in extracting juice from comestibles without any preparation, and which is suitable for domestic use.

The invention provides a juice extractor for extracting juice from comestibles comprising at least one wall delimiting a cavity for receiving a comestible and having a longitudinal axis, wherein at least a part of the wall of the cavity is moveable transversely towards the longitudinal axis so as to apply a compressive force to the comestible in a substantially radial direction.

By applying a compressive force in a substantially radial direction, the skin of the comestible is supported as the comestible is compressed, thereby preventing it from splitting and reducing the risk of zest contaminating the extracted juice.

Preferably, the cavity is delimited by a side wall and the whole of the side wall is moveable transversely towards the longitudinal axis so as to apply a compressive force to the comestible in a substantially radial direction. This arrangement ensures that the compressive force is applied evenly to the surface of the comestible which further reduces the risk of the skin splitting.

It is desirable that a pressing mechanism is provided for applying a force to the wall so as to cause the wall to move transversely towards the longitudinal axis, and that the pressing mechanism is adapted to apply the force to the wall substantially in the direction of the longitudinal axis. This has the advantage of allowing the juice extractor to be efficiently packaged which offers space-saving benefits and manufacturing efficiencies.

In a preferred embodiment, the wall of the cavity is formed by a deformable, substantially incompressible member. This arrangement minimizes the number of parts which need to be cleaned after the juice extractor has been used and also reduces the risk of mechanical failure. It is equally possible to apply the substantially radial compressive force by providing a plurality of arms located radially outwardly of the wall delimiting the cavity, the arms being moveable in a direction transverse to the longitudinal axis to move at least a part of the wall in a substantially radial direction. In this case, it is preferred that the substantially radial compressive force be applied to the comestible as a result of the application of a force in the direction of the longitudinal axis so as to effect movement of the arms in a direction transverse to the longitudinal axis. This allows a compact arrangement which has obvious advantages for domestic appliances.

The invention also provides a method of extracting juice from a comestible comprising the steps of:

(a) introducing a comestible to a cavity delimited by at least one wall and having a longitudinal axis; and

(b) causing at least a part of the wall to be moved transversely towards the longitudinal axis to apply a compressive force to the comestible in a substantially radial direction.

The application of a substantially radial compressive force again ensures that the skin of the comestible is supported which reduces the risk of zest contaminating the extracted juice.

It is preferred that the substantially radial compressive force is applied by the application of a force in the direction of the longitudinal axis.

Other advantageous features are set out in the detailed description below.

### BRIEF DESCRIPTION OF THE DRAWINGS

Embodiments of the invention will now be described with reference to the accompanying drawings in which:

FIG. 1 is a perspective view of a juice extractor according to the invention;

FIG. 2 is a perspective view, similar to FIG. 1, of the juice extractor with the spout extended and the door in an open position;

FIG. 3 is a section through the juice extractor of FIG. 1 showing the position of various components at the start of the juice extracting process;

FIG. 4 is a perspective view showing the component of the juice extractor of FIG. 1 which effects the application of a radial compressive force on the comestible to be processed;

FIG. 5 is a section through the component of FIG. 4;

FIG. 6 is a view showing the components of the juice extractor of FIG. 1 which apply a force to the component shown in FIG. 4;

FIG. 7 is a view showing the components of the juice extractor of FIG. 1 via which juice is passed from the comestible to the spout;

FIG. 8 is a sectional view, similar to FIG. 3, showing the position of the various components at a second stage of the juice extracting process;

FIG. 9 is a sectional view, similar to FIG. 3, showing the position of the various components at a third stage of the juice extracting process;

FIG. 10 is a sectional view, similar to FIG. 3, showing the position of the various components at a fourth stage of the juice extracting process;

FIG. 11 is a perspective view, similar to FIG. 4, of a first alternative component for use in the juice extractor of FIG. 1;

FIG. 12 is a sectional view, similar to FIG. 5, of a second alternative component for use in the juice extractor of FIG. 1;

FIG. 13 is a side view of an alternative mechanism for applying a substantially radial compressive force to a comestible placed in the juice extractor of FIG. 1, the mechanism being shown in a first position; and

FIG. 14 is a side view of the mechanism of FIG. 12 shown in a second position.

### DETAILED DESCRIPTION OF THE INVENTION

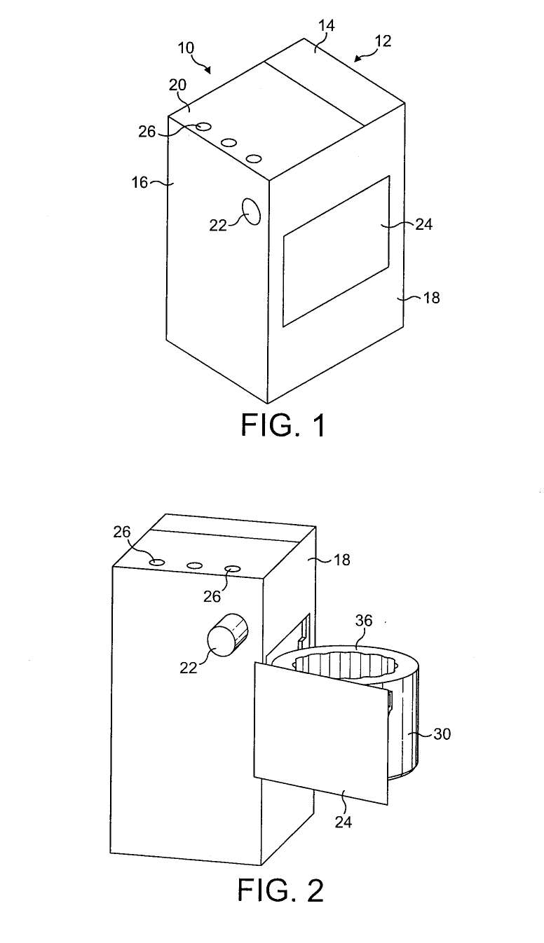

A juice extractor according to the invention is shown in FIGS. 1 and 2. The juice extractor 10 has a substantially box-shaped outer housing 12 having an upper surface 14, a front surface 16 and a side surface 18. The surfaces not visible in FIGS. 1 and 2 are planar and substantially featureless, save for an electrical connection provided in either the rear surface or the base to allow connection to a suitable mains supply. The upper surface 14 includes a hinged lid 20 to allow access to interior components when cleaning is required. The front surface includes a retractable and extendable spout 22 which is shown in the retracted position in FIG. 1 and in the extended position in FIG. 2. The side wall 18 incorporates a hinged door 24 which opens to allow the comestible from which juice is to be extracted to be placed in the juice extractor. The door 24 is shown in the closed position in FIG. 1 and in the open position in FIG. 2. Buttons 26 in the form of capacitive sensors are provided on the upper surface 14 close to the front surface 16. These can be located under and protected by the lid 20 or can be provided in any other location convenient for the user. The buttons 26 are arranged to cause the spout 22 to extend and retract, to cause the door 24 to open and close, and to start the juice extraction process. Further buttons 26 can be provided to activate different processes or operations as necessary.

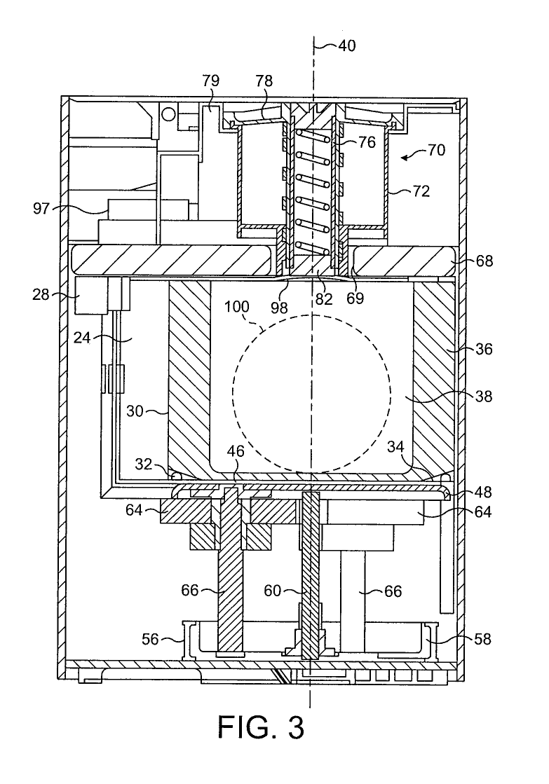

FIG. 3 illustrates the interior components of the juice extractor of FIGS. 1 and 2. Part of the door 24 can be seen, along with a catch 28 for retaining the door 24 in the closed position. Secured to the interior face of the door 24 is a rigid cylindrical sleeve member 30. The cylindrical sleeve member 30, which is also visible in FIG. 2, has an open upper end and an inwardly projecting lip 32 at its lower end. Seated on the lip 32 is a loose-fitting base 34 which is permitted to move upwardly inside and with respect to the cylindrical sleeve member 30. The cylindrical sleeve member 30, together with the base 34, is carried by the door 24 and moveable therewith on operation of the appropriate button 26 to release the catch 28.

Located inside the cylindrical sleeve member 30, and supported by the base 34, is a deformable member 36. The deformable member 36, which can also be seen in FIG. 2, is externally dimensioned so as to fill the space delimited by the cylindrical sleeve member 30 and the base 34 leaving substantially no play. The wall of the cylindrical sleeve member 30 is thus positioned immediately radially outwardly of the deformable member 36 and the base 34 is positioned immediately beneath the deformable member 36. The deformable member 36 is made from a substantially incompressible material such as silicone and, preferably, has properties which allow the deformable member 36 to be washed in a dishwasher. For this application, the material must be of a standard which is suitable for use with foodstuffs. Additionally, the material from which the deformable member 36 is manufactured has a Shore A hardness of no more than 30, with a Shore A hardness of up to 10, preferably no more than 5, being preferred. The purpose of this property will be explained below.

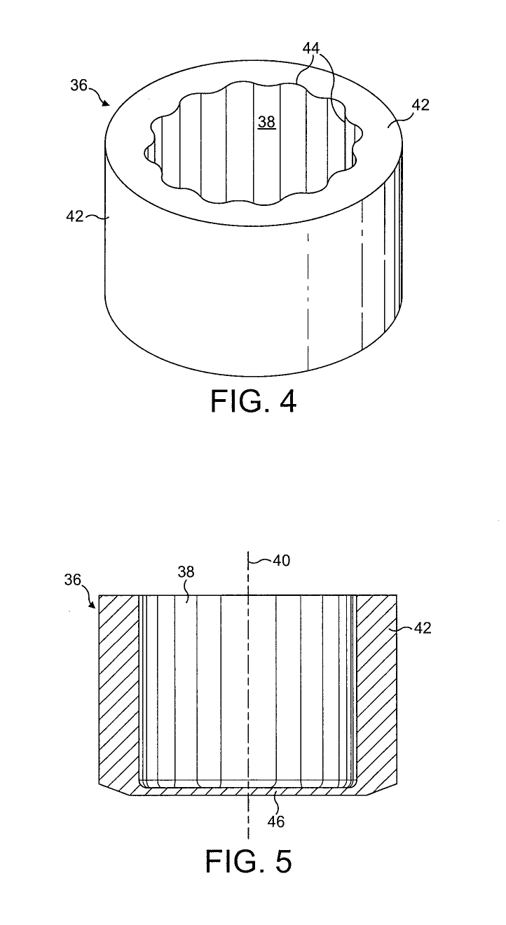

Internally, the deformable member 36 delimits a generally cylindrical cavity 38 which is dimensioned so as to be capable of receiving fruits or vegetables of varying sizes. The cavity 38 has a longitudinal axis 40 about which the deformable member 36 is located. The deformable member 36, which is shown more clearly in FIGS. 4 and 5, has a side wall 42 which, in use, surrounds the comestible from which juice is to be extracted, and is shaped so as to form a plurality of lobes 44 which are circumferentially spaced about the longitudinal axis 40. In the embodiment shown, twelve equi-angularly spaced lobes 44 are provided: however, as few as five or as many as twenty lobes can be provided with good effect. One of the purposes of the lobes 44 is to allow a comestible having a girth which is slightly bigger than the internal circumference of the cavity 38 to be accommodated by slight compression of the lobes. The deformable member 36 also has a base 46 which closes the lower end of the deformable member 36. The base 46 is formed integrally with the side wall 42 so that the entire deformable member 36 can be manufactured in a single piece, although this is not essential. When the deformable member 36 is placed inside the cylindrical sleeve member 30, the base 46 of the deformable member 36 rests on and is supported by the base 34.

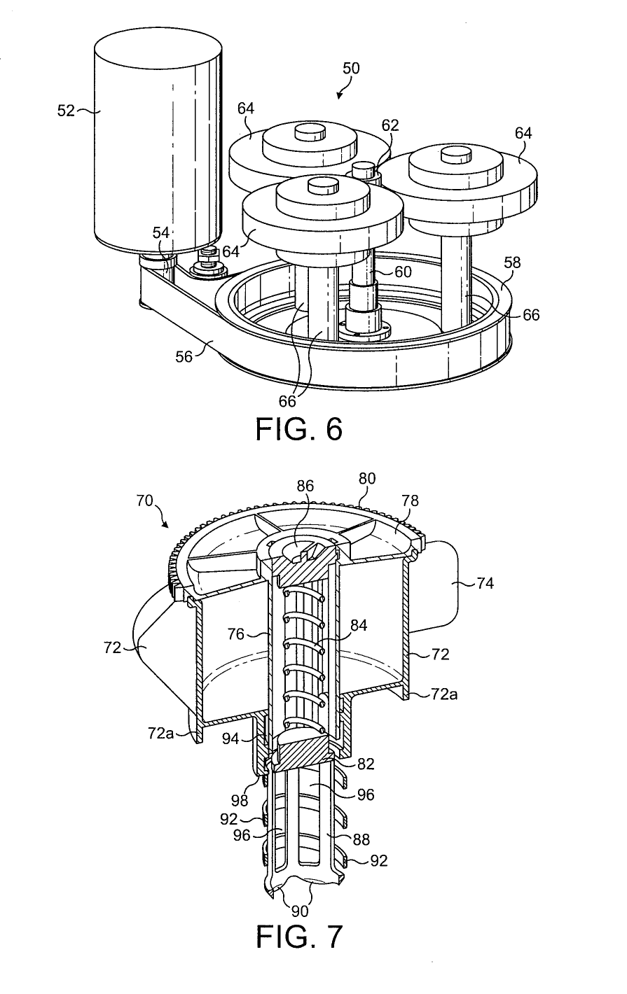

When the deformable member 36 is located inside the cylindrical sleeve member 30 and the door 24 is in the closed position, a circular plate 48 is positioned immediately beneath the base 34. Below the plate 48, a pressing mechanism 50 is provided, all the components of which are contained within the housing 12. The pressing mechanism 50 is shown in detail in FIG. 6 and comprises a motor 52 which is mounted so that the shaft 54 thereof extends generally downwards towards the base surface of the juice extractor 10. The shaft 54 drives a belt 56 which in turn drives the pulley 58 of a shaft 60 which is rotatably mounted on the base surface. At the upper end of the shaft 60 is a first gear 62 which meshes with three further gears 64, each of which is rotatably supported at a fixed distance above the base surface and surrounds a lead screw 66. Each lead screw 66 cooperates with the respective gear 64 by means of which, when the gear 64 rotates, the lead screw 66 is drawn through the centre of the gear 64 in a direction which depends upon the direction of rotation of the gear 64. Thus, in operation, when the motor 52 is driven in a particular direction, the gear 62 at the upper end of the shaft 60 causes the gears 64 to rotate which, in turn, causes the lead screws 66 to move in an upward direction.

The upper ends of the lead screws 66 are in contact with the underneath surface of the circular plate 48, as can be seen from FIG. 3. Thus, when the lead screws 66 are moved in an upward direction, the circular plate 48 is also caused to move in an upward direction which, in turn, causes the base 34 to move in an upward direction. The operation of the juice extractor will be described in more detail below.

A plate 68 is located immediately above the open upper end of the rigid cylindrical sleeve 30. This plate 68 does not restrict the ability of the cylindrical sleeve 30 and the deformable member 36 to move with the door 24 between the open and closed positions, but it does ensure that the deformable member 36 may not move out of the cylindrical sleeve 30 to any significant extent when the door 24 is in the closed position. The purpose of the plate 68 is to ensure that, when the plate 48 is raised, the deformable member 36 is compressed in the direction of the longitudinal axis 40. An aperture 69 is arranged in the plate 68 and is aligned with the longitudinal axis 40 of the cavity 38.

Located above the plate 68 is a juice collection mechanism 70. The juice collection mechanism 70 is shown in more detail in FIG. 7 and comprises a reservoir 72 which extends between the plate 68 and the upper surface 14 of the juice extractor 10. The reservoir 72 is generally cylindrical in shape and has a conduit 74 leading from the interior of the reservoir 72 to the spout 22. The conduit 74 is in communication with the spout 22 and is shaped so that liquid collected in the reservoir 72 will run into the conduit 74 and thence to the spout 22 under the influence of gravity. A cylindrical sleeve 76 is mounted generally in the centre of the reservoir 72 and is rigidly connected to a circular cap 78 which forms a lid to the reservoir 72. The cap 78 is mounted on the upper end of the wall of the reservoir 72 so as to be rotatable with respect thereto. The outer lip of the cap 78 carries gear teeth 80 which engage with gear teeth carried by the shaft of a drive motor 79 (see FIG. 3) located in the upper portion of the juice extractor 10 so that the cap 78 can be driven in a rotating manner with respect to the reservoir 72 by operation of the drive motor 79. The cylindrical sleeve 76 extends downwardly away from the circular cap 78 and into the aperture 69 in the plate 68. The cylindrical sleeve 76 does not project beyond the lower surface of the plate 68. When the circular cap 78 is rotated by the drive motor 79, the cylindrical sleeve 76 will rotate together therewith. The cylindrical sleeve 76 includes elongate slots to allow juice to pass from the interior of the sleeve 76 to the exterior thereof.

Located inside the cylindrical sleeve 76 is a plunger 82 which is slidably moveable inside the cylindrical sleeve 76. A spring 84 biases the plunger 82 into a position in which it lies at the lower end of the cylindrical sleeve 76 and substantially level with the lower surface of the plate 68. In this position, the plunger 82 lies immediately above the cavity 38 formed in the deformable member 36 when the door 24 is in the closed position. The upper end of the spring 84 abuts against a stop 86 which forms the central portion of the cap 78. The stop 86 may rotate with the cap 78, depending upon the connection between the cap 78 and the stop 86. The spring 84 may rotate with respect to the stop 86 and/or the plunger 82. It is immaterial whether any of the stop 86, the spring 84 and the plunger 82 is caused to rotate with respect to the cylindrical sleeve 76 when the cap 78 is rotated by the drive motor 79.

A cutter sleeve 88 lies immediately outside the cylindrical sleeve 76. The cutter sleeve 88 includes at least one blade portion 90 located at the lowermost end thereof. The or each blade portion 90 is capable of cutting through the rind of a citrus fruit. The cutter sleeve 88 also comprises helical tongues 92 which engage with grooves 94 formed in the lowermost portion of the cylindrical sleeve 76. The arrangement is designed to ensure that, when the cylindrical sleeve 76 is rotated by the drive motor 79 as described above, the cutter sleeve 88 is caused to move upward or downward (depending upon the direction of rotation of the cylindrical sleeve 76) by virtue of the relative rotation between the cylindrical sleeve 76 and the cutter sleeve 88 and the interaction between the tongues 92 and the grooves 94. Slots 96 are provided in the cutter sleeve 88 to allow pulp and juice to pass from the outside of the cutter sleeve 88 to the inside thereof.

The juice extractor 10 also includes electronic circuitry 97 which controls the operation of the juice extractor 10. The electronic circuitry 97 can be located in any suitable position within the outer housing 12 but is conveniently located within the portion of the extractor shown in the upper left hand corner of FIG. 3. The electronic circuitry 97 is adapted and arranged to drive the motor 52 which causes the plate 48 to be raised and lowered, to sense whether the door 24 is open or closed, and to drive the drive motor 79 so as to rotate the cap 78. The electronic circuitry 97 is also connected to a sensor 98 located on the underside of the plate 68 at or adjacent the aperture 69. The sensor 98 could equally be provided on the lowermost extremity of a portion of the underside of the reservoir 72 which projects into the aperture 69 as shown in FIG. 7. This sensor 98 is adapted to sense the presence of a comestible 100 which is being pressed against the underside of the plate 68.

The operation of the juice extractor 10 will now be described in detail. The process will be described in relation to the extraction of juice from citrus fruit, although other types of comestible, such as fruit and vegetables, can be juiced in the same or a similar way. Initially, the spout 22 is extended and the door 24 of the juice extractor 10 is opened by pressing the appropriate button(s) 26 on the upper surface 14 of the outer casing 12. A receptacle such as a drinking glass is placed beneath the spout 22 and a piece of citrus fruit 100 is introduced to the interior of the deformable member 36 simply by dropping the fruit 100 into the cavity 38 so that the side wall 42 surrounds the fruit 100. The juice extractor 10 described above is capable of extracting juice from fruit having a height of anything between about 55 mm and about 90 mm, the upper limit being determined by the ability of the door 24 to be closed with the fruit placed inside the cavity 38. Since some fruit has a slightly flattened shape, as opposed to being truly spherical, fruit which has a height of no more than 90 mm but a girth which is slightly larger than that which can easily be accommodated within the cavity may need to be pressed into the cavity 38 so as to deform slightly the inner portions of the lobes 44. Once the fruit has been placed in the cavity 38, the door 24 is closed either manually or by pressing the appropriate button 26. The juice extractor 10 is then in the position shown in FIG. 3. The fruit 100 is in the cavity 38; the plate 48 is in its lowermost position; the deformable member 36 is substantially undeformed; the cutter sleeve 88 is in its uppermost position with the blade portions 90 lying within the aperture 69 and immediately above the cavity 38; the plunger 82 is in its lowermost position with its lowermost face lying immediately above the cavity 38; and the spring 84 is unstressed.

Pressing the appropriate button 26 will initiate the juice extraction process. Firstly, the electronic circuitry 97 will carry out a check to ensure that the door 24 is fully closed. If it is not, there will be a risk that the cylindrical sleeve 30 will not be aligned properly with the plate 48 and further operation could damage the appliance. If an error is detected, a warning light, sound or message could be displayed. If the door 24 is correctly closed, the electronic circuitry 97 will drive the motor 52, activating the pressing mechanism 50 as described above and causing the plate 48 to be lifted towards the plate 68. The positioning of the plate 48 immediately beneath the base 34, and the fact that the base 34 is loose-fitting with respect to the cylindrical sleeve member 30, means that the lifting of the plate 48 causes the base 34 to be lifted as well. Since the cylindrical sleeve member 30 and the plate 68 are each rigidly fixed, the lifting of the base 34 causes the side wall 42 of the deformable member 36 to be deformed inwardly towards the axis 40. At the same time, the base 46 of the deformable member 36 is pressed upwardly towards the plate 68. Effectively, the volume of the cavity 38 is reduced. The physical properties of the deformable member 36, and in particular the Shore A hardness being close to 5, ensure that, when the axial force is applied by the pressing mechanism 50 to the deformable member 36, the deformable member 36 is able elastically to alter its shape but substantially maintain its volume. In this way, the axial force applied to the deformable member 36 is translated into a substantially radial compressive force.

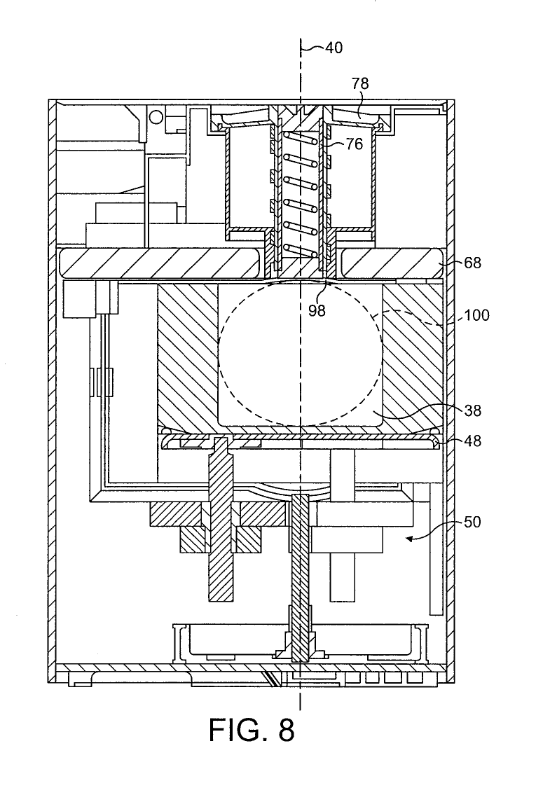

There will come a point, as the plate 48 is raised towards the plate 68, when the fruit 100 will come into contact with the plate 68. This position is shown in FIG. 8. The sensor 98 detects this and communicates with the electronic circuitry 97 that this point has been reached. At this stage, the motor 52 is stopped and the time which has elapsed since the pressing mechanism 50 was first activated is recorded. The elapsed time is indicative of the size of the piece of fruit 100 from which juice is to be extracted. Using this information, a calculation is made of the distance into the fruit 100 which the cutter sleeve 88 will be pressed and the distance by which the plate 48 should then be raised beyond its present position to effect squeezing of the fruit 100. This calculation takes account of the size of the fruit 100 as calculated with reference to the time taken for the fruit 100 to be brought into contact with the plate 68. The larger the size of the fruit 100, the further the cutter sleeve 88 will be driven into the fruit 100. In this embodiment, when a piece of fruit 100 of maximum height (90 mm) is to be juiced, the cutter sleeve 88 will be driven into the fruit 100 to a distance of 40 mm, or approximately 45% of the original height of the piece of fruit 100. When a piece of fruit 100 of minimum height (55 mm) is to be juiced, the cutter sleeve 88 will be driven into the fruit 100 to a distance of 35 mm, or approximately 64% of the original height of the piece of fruit 100. For fruit having a height between 55 mm and 90 mm, the cutter sleeve 88 will be driven into the fruit to a distance of between 35 mm and 40 mm using a directly linear relationship, so that the penetration of the cutter sleeve 88 into a piece of fruit having a height of 72.5 mm will be 37.5 mm, or approximately 52% of the original height of the fruit. It will be appreciated that the distance to which the cutter sleeve 88 is driven into the fruit 100 can be varied in any appropriate relationship and will be dependent upon the material and geometry of the deformable sleeve 36.

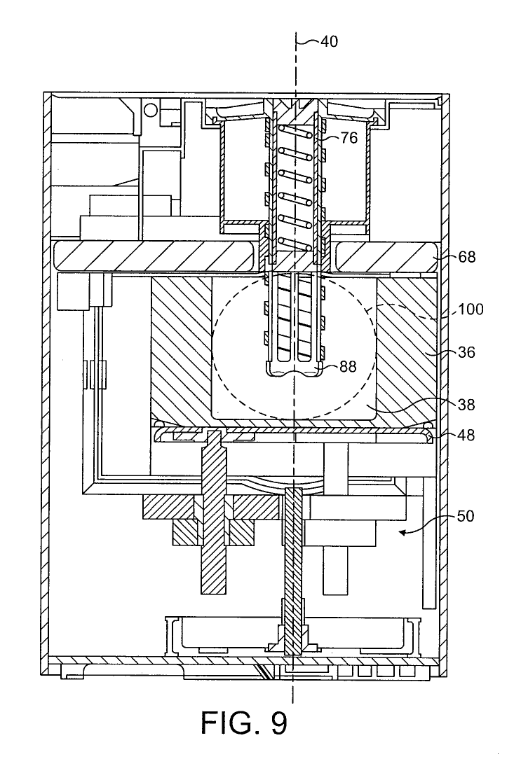

Before the cutter sleeve 88 is driven into the fruit 100, the motor 52 is driven again so as to raise the plate 48 by a predetermined distance (in this embodiment around 10 mm) in order to ensure that the skin of the fruit 100 is pressed firmly against the underside of the plate 68 to reduce the risk of any premature leakage of juice into the interior of the cylindrical sleeve 76 and to reduce the risk of zest or peel oil from the fruit 100 contaminating the extracted juice. The drive motor 79 is then driven so that the cap 78 and the cylindrical sleeve 76 are rotated about the axis 40. This causes relative rotation between the cylindrical sleeve 76 and the cutter sleeve 88, thus moving the cutter sleeve 88 downwards. The cutter blades 90 pierce the rind of the fruit 100 and continued driving of the drive motor 79 forces the cutter sleeve 88 into the interior of the cavity 38 and thus into the interior of the fruit 100. The drive motor 79 is driven until the distance calculated by the electronic circuitry 97 as being the appropriate distance for the cutter sleeve 88 to travel is completed. The position achieved by the components at this stage is shown in FIG. 9.

Once the cutter sleeve 88 has been driven into the fruit 100 to the correct distance, the motor 52 is operated once again. The plate 48 is pressed further upwards towards the plate 68 until it is positioned approximately 5 mm below the lowermost end of the cutter sleeve 88. During this part of the operation, the deformable member 36 is deformed to such an extent that the volume of the cavity 38 is again greatly reduced. The constraints placed on the external dimensions of the deformable member 36 by the cylindrical sleeve 30 force the deformable member 36 to apply a very substantial force to the fruit 100 in a substantially radial direction, that is, substantially perpendicular to the longitudinal axis 40. An axial force is also applied to the fruit 100 by virtue of the plate 48 continuing to be raised towards the plate 68. The lobes 44 of the deformable member are substantially equally spaced about the axis 40 and so support the skin of the fruit 100 as the squeezing forces are applied and this helps to reduce the risk of the skin splitting and zest or juice oils contaminating the extracted juice. As this substantially radial squeezing process takes place, juice and pulp of the fruit 100 pass through the slots 96 in the cutter sleeve 88 into the interior of the cutter sleeve 88. Continued squeezing forces the pulp and juice to occupy some of the interior of the cylindrical sleeve 76 and the plunger 82 is forced to move upwardly against the biasing action of the spring 84. The pressing of the plunger 82 towards the fruit 100 compresses the pulp and squeezes juice through the slots 96 in the cylindrical sleeve 76. The slots are designed to allow juice, but not pulp, to pass therethrough. However, the slots 96 may be dimensioned to allow a small amount of pulp to pass therethrough if juice-containing pulp is required.

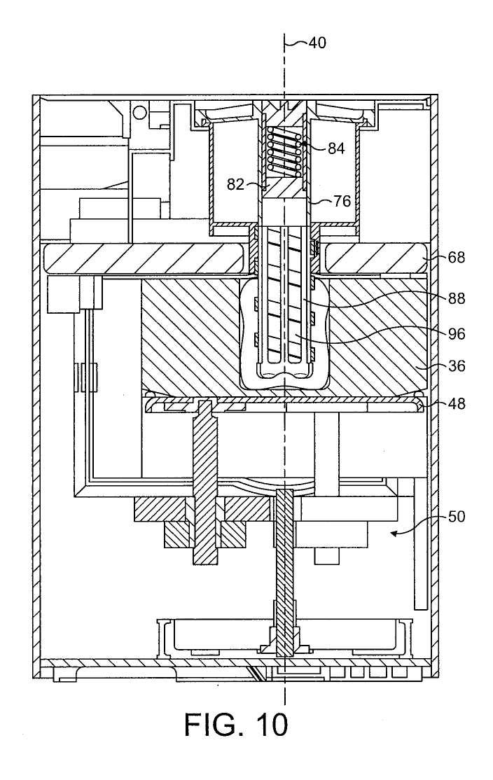

The final position of the plate 48 is calculated by the electronic circuitry 97 and is dependent on the size of the fruit 100. It is essential that the final position of the plate 48 is below the lowermost end of the cutter sleeve 88 when it is in its lowered position. However, in order to extract the maximum amount of juice from the fruit 100, the plate 48 should be relatively close to the lowermost end of the cutter sleeve 88 in its final position. The positions of the various components at this stage are shown in FIG. 10.

As a result of the squeezing of the pulp and juice into the interior of the cutter sleeve 88 and the cylindrical sleeve 78, and the compression of the pulp by the plunger 82, juice from the fruit 100 passes into the reservoir 72 and drains from there to the spout 22. It will be appreciated that the juice extracted from the fruit 100 is forced upwards out of the fruit—against the force of gravity—but this is achievable due to the large compression forces applied to the fruit 100 by the deformation of the deformable member 36. Forcing the extracted juice to travel upwards to the reservoir 72 allows the spout 22 to be positioned at an appropriate height for dispensing extracted juice into a drinking glass while still allowing the fruit 100 to occupy a position below the spout 22.

Once the squeezing operation has been completed, the cutter sleeve 88 is retracted from the fruit 100 by driving the drive motor in the reverse direction. This moves the cutter sleeve 88 upwardly and returns it to a position in which the cutter blades 90 are located above the cavity 38, externally of the fruit 100. The motor 52 is then driven in a reverse direction so that the plate 48 is lowered to its original position (as shown in FIG. 3). This releases the pressure on the deformable member 36 which then returns to its original shape as shown in FIGS. 4 and 5 so that the shape and volume of the cavity 38 returns to that shown in FIG. 3. These steps can be carried out sequentially or simultaneously. Although the fruit 100 remains a fraction of its original volume, it is no longer under pressure so the spring 84 is able to press the plunger 82 downwards towards the fruit 100. This action pushes the majority of the pulp back into the interior of the fruit 100 and the circular disc of rind which was originally cut through by the cutter blades 90 will be pushed back towards its original position in the fruit 100. This means that the waste material to be discarded by the user is contained, to a very large extent, within the original skin of the fruit 100. Because the skin has been supported during the juice extraction process, the skin is not messy and is easy and clean to dispose of.

When the plate 48 has been returned to its original position, the appropriate button 26 can be pressed to open the door 24, the fruit skin can be removed from the cavity 36 and discarded, and the juice extractor 10 can either be used again immediately or cleaned in preparation for storage and future use.

Cleaning the juice extractor 10 shown in FIGS. 1 to 10 is designed to be easy and quick. The deformable member 36 can be lifted out of the cylindrical sleeve 30 and washed with ease, either by hand or using a dishwasher. The entire juice collection mechanism 70 shown in FIG. 7 can also be lifted out of the juice extractor 10 via the opening created by lifting the hinged lid 20 and then washed to remove any residue from the juice extraction process. To achieve this, the opening created by lifting the hinged lid is located immediately above the juice collection mechanism 70 and is sufficiently large to allow the entire juice collection mechanism 70 to pass through the opening. Removal of the juice collection mechanism 70 is achieved simply by the user grasping the wall of the reservoir 72 and lifting the juice collection mechanism 70 in an upward direction. The lower end of the cylindrical sleeve 76 is slidably releasable from the aperture 69 in the plate 68 and lifting the juice collection mechanism 70 in an upwards direction disengages the cylindrical sleeve 76 from the aperture 69. The plate 68 carries or incorporates formations (not shown) with which shapings 72a formed on the base of the reservoir 72 engage. These formations and shapings 72a are non-symmetrical to ensure that the juice collection mechanism 70 is always replaced in the correct orientation after removal from the juice extractor 10. This is important because the conduit 74 must be returned to the position in which it is in communication with the spout 22 after cleaning. An appropriate seal (not shown) can be provided between the conduit 74 and the spout 22 if desired.

It will be appreciated that the cutter sleeve 88 will normally be located in its retracted position around the cylindrical sleeve 76 (as in FIGS. 3 and 8) when the juice collection mechanism 70 is removed from the juice extractor 10 for cleaning purposes. However, it may be necessary to move the cutter sleeve 88 into the extended position (as in FIG. 9) for cleaning in some instances. If this is necessary, the cap 78 can be rotated manually to bring the cutter sleeve 88 into the extended position for cleaning purposes but it is preferred that the cutter sleeve 88 be returned to the retracted position for replacement into the juice extractor 10. It is also envisaged that the cap 78, together with the cylindrical sleeve 76 and the cutter sleeve 88, will be separable from the reservoir 72 during the cleaning process.

The fact that the juice collection mechanism 70 is located entirely above the plate 68, and thus in the upper portion of the juice extractor 10, means that the removal of the juice collection mechanism 70 is very convenient for the user because access to the juice collection mechanism 70 is not inhibited by other components of the juice extractor 10.

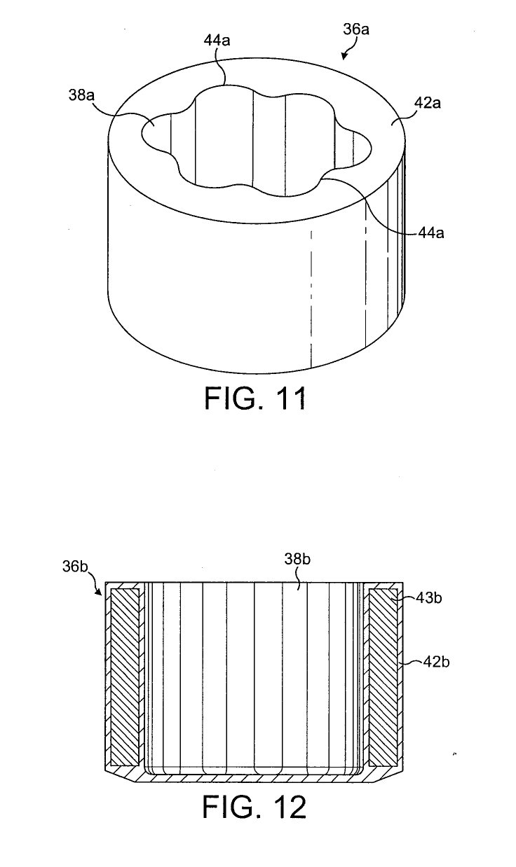

The deformable member 36 described above can be replaced by alternative designs of deformable member. A first alternative design of deformable member which could replace the deformable member 36 is shown in FIG. 11. In this alternative design, the deformable member 36a is similarly configured with a generally cylindrical side wall 42a and a base (not shown) delimiting a generally cylindrical cavity 38a. The external dimensions of the side wall 42a are essentially the same as those of the side wall 42 of the deformable member 36 so that the alternative deformable member 36a will fit into the cylindrical sleeve member 30 without any substantial play. The main difference between the deformable member 36 and the alternative deformable member 36a is the number of lobes 44a provided on the side wall 42a. In the embodiment of FIG. 11, only six lobes 44a are provided. It has been found that any number of lobes between 5 and 20 can be provided to good effect.

A second alternative design of deformable member is shown in FIG. 12. In this alternative design, the deformable member 36b again has a general configuration which would allow it to fit into the cylindrical sleeve member 30 and to accept comestible vegetables in a cavity 38b. However, the wall 42b of the deformable member 36b is manufactured so as to include an internal cavity 43b which is filled with an incompressible substance during the manufacturing process. The density of the incompressible substance (which may be water) is different from that of the material from which the wall 42b is manufactured. This can enhance the properties which allow the deformable member 36b to apply compressive forces to the comestible during the juice extracting process. It can also have cost benefits and may also reduce the weight of the final product.

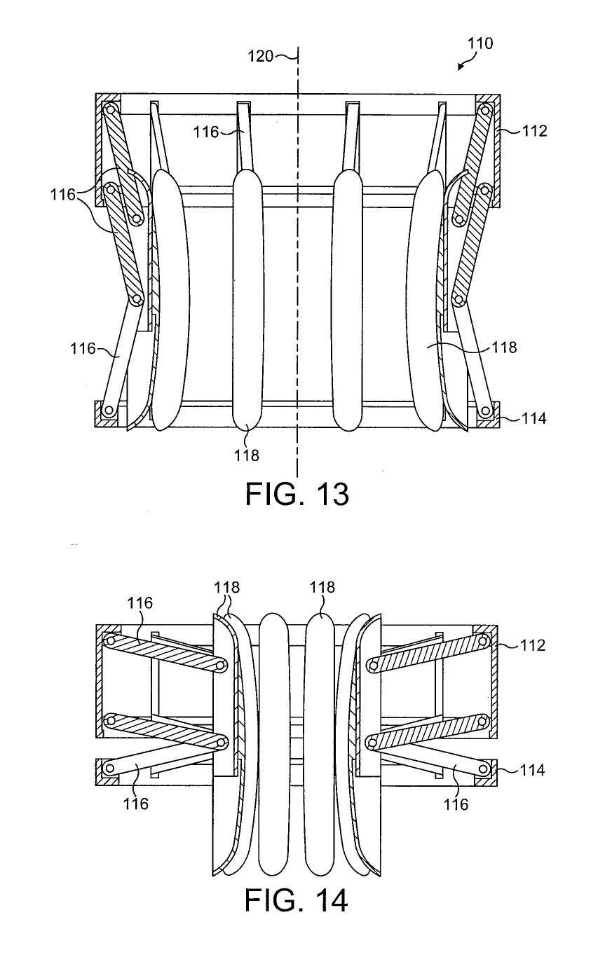

The deformable members 36, 36a, 36b described above are not the only means of applying a substantially radial force to the comestible in the juice extractor of FIGS. 1 to 10. Mechanical means can also be used to apply a similar force to the comestible. An example of such mechanical means in the form of a mechanical press ring 110 is shown in FIGS. 13 and 14. As can be seen in FIG. 13, the mechanical press ring 110 includes an upper ring structure 112 and a lower ring structure 114. The upper ring structure 112 and the lower ring structure 114 are connected by a series of linkages 116 on each of which is carried a pressing arm 118. The arrangement shown includes ten linkages 116 equi-spaced about a central axis 120 defined by the upper and lower ring structures 112, 114. There are, therefore, ten equi-spaced pressing arms 118 included in the structure. The linkages 116 are arranged so that, when the lower ring structure 114 is moved upwardly towards the upper ring structure 112, the pressing arms 118 are moved radially inwardly towards the axis 120 as shown in FIG. 14.

The mechanical ring press 110 can be incorporated into the juice extractor 10 shown in FIGS. 1 to 10 by removing the deformable member 36 and with some slight modifications to the plates 48, 68 and the pressing mechanism 50 to accommodate the pressing arms 118. However, it can readily be seen that a result similar to that described in detail above can be achieved using a mechanism shown in FIGS. 13 and 14 in place of the deformable member 36. Different numbers of pressing arms 118 can be used in the same way that the number of lobes 44 can be varied on the deformable member 36. It is preferred that, when the mechanical press ring 110 is employed, a removable flexible sleeve (not shown) will be placed between the comestible 100 and the pressing arms 118, partly to help to distribute the load applied to the comestible and partly to enable the portion of the appliance in direct contact with the comestible 100 to be removed for cleaning purposes.

The invention is not limited to the specific embodiment described in detail above. Various modifications can be made to the details of the appliance shown in the attached figures without departing from the scope of the invention. For example, the outer housing need not be a simple box shape but could take any appropriate shape in order to house the internal components. For built-in designs, no outer housing need be provided at all. The door does not need to be arranged on the side wall but could be, for example, on the front surface. The spout could equally be located in either side wall and need not be retractable. A different user interface can be provided, and additional functionality could be built into the device. There are alternative ways of providing the axial compressing force to the deformable member, such as hydraulic systems, and any pressing mechanism which achieves the same effect can be used, either in the orientation described above or in another orientation, such as inverted. Furthermore, the distance between the plate 48 and the lowermost end of the cutter sleeve 88 need not be 5 mm, but can be varied to any suitable value. Values of anywhere between 2 mm and 10 mm would be suitable for most applications.

The deformable members illustrated in FIGS. 4, 5, 11 and 12 can also be varied to include different numbers of lobes and/or different lobe profiles. Indeed, the lobes can be dispensed with entirely if desired and the base 46 can be manufactured separately from the side wall and either connected thereto by any suitable means. Equally, the mechanical press ring illustrated in FIGS. 13 and 14 can take any one of a variety of forms which achieve the same result as that shown and described. The cylindrical sleeve member 30 could be made removable with the deformable member 36 by providing a releasable connection between the cylindrical sleeve member 30 and the door 24. The cutter sleeve may also be controlled in a way which is independent of the size of the comestible so that the cutter blade is pressed into the comestible to a predetermined distance on each and every occasion. Alternatively, the cutter sleeve could be controlled so that it is pressed into the comestible to one of a number of discrete, predetermined distances depending upon the size of the comestible. Furthermore, the cutter sleeve can be turned off completely if comestibles having no rind (for example strawberries) or fruit having a stone (for example peaches or mango) is to be juiced. In this case, an additional button would be provided to allow the user to select a method of operation taking account of the type of comestible to be juiced or the absence of rind from the comestible. The cutter sleeve 88 could even be omitted from the juice extractor 10 for exclusive use in relation to comestibles having no rind or having stones. In this case, a fixed cutter blade could be provided on the underside of the plate 68 around the aperture 69, although such a blade may not be necessary for use with comestibles having soft or no skin.

It is also envisaged that a cover may be provided on the deformable member so that the cavity into which the comestible is placed is substantially enclosed by the deformable member. This may assist in ensuring that the appliance is easy to clean. The cover may be movably fixed to the deformable member or simply alignable with the deformable member so as to be removable therewith for cleaning purposes. This eliminates any need for the underneath surface of the plate located above the deformable member to be cleaned since any juice, pulp, zest or peel oil which finds its way into that area will be lodged on the cover and thus removed when the deformable member is removed for cleaning. The deformable member need not be made from silicone but can be made from any suitable material with the appropriate hardness characteristics, such as a thermoplastics material or polyurethane.

1. A juice extractor for extracting juice from comestibles, comprising at least one wall delimiting a cavity within a body of the juice extractor for receiving a comestible and having a longitudinal axis, wherein at least a part of the wall of the cavity is moveable transversely towards the longitudinal axis so as to apply a compressive force to the comestible in a substantially radial direction relative to the longitudinal axis.

2. The juice extractor of claim 1, wherein the cavity is delimited by a side wall and the whole of the side wall is moveable transversely towards the longitudinal axis so as to apply a compressive force to the comestible in the substantially radial direction.

3. The juice extractor of claim 1, further comprising a pressing mechanism for applying a force to the wall so as to cause the wall to move transversely towards the longitudinal axis.

4. The juice extractor of claim 3, wherein the pressing mechanism is adapted to apply the force to the wall substantially in the direction of the longitudinal axis.

5. The juice extractor of claim 1, wherein the cavity is delimited by a base wall which is moveable in the direction of the longitudinal axis so as to apply a substantially axial compressive force in addition to the substantially radial compressive force.

6. The juice extractor of claim 1, wherein the cavity is delimited by a deformable member.

7. The juice extractor of claim 6, wherein the deformable member is substantially incompressible.

8. The juice extractor of claim 7, wherein the deformable member is made from silicone.

9. The juice extractor of claim 8, wherein the silicone has a Shore A hardness of no more than 30.

10. The juice extractor of claim 9, wherein the silicone has a Shore A hardness of up to 10.

11. The juice extractor of claim 10, wherein the silicone has a Shore A hardness of about 5.

12. The juice extractor of claim 6, wherein the deformable member is generally cylindrical.

13. The juice extractor of claim 12, wherein the deformable member has a plurality of inwardly projecting lobes arranged around the longitudinal axis.

14. The juice extractor of claim 13, wherein the number of lobes is between 5 and 20.

15. The juice extractor of claim 14, wherein the number of lobes is 12.

16. The juice extractor of claim 6, wherein the cavity is delimited by a base which is formed integrally with the deformable member.

17. The juice extractor of claim 6, further comprising a rigid retaining wall located radially outwardly of the deformable member to prevent outward deformation thereof.

18. The juice extractor of claim 1, wherein a plurality of arms are located radially outwardly of the wall delimiting the cavity, the arms being moveable in a direction transverse to the longitudinal axis to move at least a part of the wall in a substantially radial direction.

19. The juice extractor of claim 18, wherein between 5 and 20 arms are provided.

20. The juice extractor of claim 19, wherein 12 arms are provided.

21. The juice extractor of claim 18, further comprising a pressing mechanism for applying a force to the arms so as to cause the arms to move transversely to the longitudinal axis.

22. The juice extractor of claim 21, wherein the pressing mechanism is adapted to apply the force to the arms substantially in the direction of the longitudinal axis.

23. A method of extracting juice from a comestible comprising the steps of:
(a) introducing a comestible to a cavity delimited by at least one wall and having a longitudinal axis; and
(b) causing at least a part of the wall to be moved transversely towards the longitudinal axis to apply a compressive force to the comestible in a substantially radial direction.

24. The method of claim 23, wherein the cavity is delimited by a side wall and the compressive force is applied to the comestible by causing the whole of the side wall to be moved transversely towards the longitudinal axis.

25. The method of claim 24, wherein the side wall is caused to move transversely to the longitudinal axis by application of a force in the direction of the longitudinal axis.

26. The method of claim 23, further comprising applying an additional compressive force to the comestible in the direction of the longitudinal axis.

27. The method of claim 23, further comprising cutting a portion of the skin of the comestible away from the remainder thereof.
